(19) United States
(12) Patent Application Publication
(10) Pub. No.: US 2026/0278859 A1
(43) Pub. Date: Sep. 17, 2026

(54) VIDEO GENERATION

(71) Applicant: Beijing Zitiao Network Technology Co., Ltd., Beijing (CN)

(72) Inventors: Yuxuan LUO, Beijing (CN); Zhengkun RONG, Beijing (CN); Lizhen WANG, Beijing (CN); Longhao ZHANG, Beijing (CN); Tianshu HU, Beijing (CN)

(21) Appl. No.: 19/568,394

(22) Filed: Mar. 16, 2026

(30) Foreign Application Priority Data
Mar. 17, 2025 (CN) 202510316208.2

(51) Int. Cl. G06T 11/00; G06V 20/40; G06V 20/59; G06V 40/16

(52) U.S. Cl. CPC G06T 11/00; G06V 20/46; G06V 20/597; G06V 40/168

(57) ABSTRACT

There are provided a video generation method and apparatus, a device, and a storage medium. The method includes: determining, based on at least one reference image of a target object, an appearance feature representation indicative of an appearance of the target object; extracting, based on a driving video corresponding to a driving object, a posture feature representation sequence; extracting, based on facial state information indicative of a facial state of the driving object, a facial state feature representation sequence; and generating, based on the appearance feature representation, the posture feature representation sequence, and the facial state feature representation sequence and using a trained video generation model, a target video, the target video including the target object, and a body posture and a facial state of the target object in the target video corresponding to the driving video and the facial state information, respectively.

### CROSS-REFERENCE

This application claims the benefit of Chinese Patent Application No. 202510316208.2, filed on Mar. 17, 2025, entitled “VIDEO GENERATION METHOD, AND APPARATUS, AND DEVICE AND STORAGE MEDIUM”, the entirety of which is incorporated herein by reference.

### FIELD

Example embodiments of the present disclosure generally relate to the field of computers, and in particular, to video generation.

### BACKGROUND

With the development of artificial intelligence-related technologies, using machine learning models to generate videos has become a popular development direction. This technology shows broad potential in application scenarios such as movie production, advertising, and video games. However, the video generation quality of traditional video generation technologies still needs to be improved.

### SUMMARY

In a first aspect of the present disclosure, a video generation method is provided. The method comprises: determining, based on at least one reference image of a target object, an appearance feature representation indicative of an appearance of the target object; extracting, based on a driving video corresponding to a driving object, a posture feature representation sequence, the posture feature representation sequence comprising a plurality of posture feature representations corresponding to a plurality of video frames in the driving video, each posture feature representation indicative of a body posture of the driving object in a corresponding video frame; extracting, based on facial state information indicative of a facial state of the driving object, a facial state feature representation sequence, the facial state feature representation sequence comprising a plurality of facial state feature representations; and generating, based on the appearance feature representation, the posture feature representation sequence, and the facial state feature representation sequence and using a trained video generation model, a target video, the target video comprising the target object, and a body posture and a facial state of the target object in the target video corresponding to the driving video and the facial state information, respectively.

In a second aspect of the present disclosure, an apparatus for video generation is provided. The apparatus comprises: a determination module configured to determine, based on at least one reference image of a target object, an appearance feature representation indicative of an appearance of the target object; a first extraction module configured to extract, based on a driving video corresponding to a driving object, a posture feature representation sequence, the posture feature representation sequence comprising a plurality of posture feature representations corresponding to a plurality of video frames in the driving video, each posture feature representation indicative of a body posture of the driving object in a corresponding video frame; a second extraction module configured to extract, based on facial state information indicative of a facial state of the driving object, a facial state feature representation sequence, the facial state feature representation sequence comprising a plurality of facial state feature representations; and a generation module configured to generate, based on the appearance feature representation, the posture feature representation sequence, and the facial state feature representation sequence and using a trained video generation model, a target video, the target video comprising the target object, and a body posture and a facial state of the target object in the target video corresponding to the driving video and the facial state information, respectively.

In a third aspect of the present disclosure, an electronic device is provided. The device comprises at least one processor; and at least one memory, the at least one memory being coupled to the at least one processor and storing instructions executable by the at least one processor, when executed by the at least one processor, causing the device to perform the method of the first aspect.

In a fourth aspect of the present disclosure, a computer-readable storage medium is provided. The computer-readable storage medium has computer-executable instructions stored thereon, the computer-executable instructions being executable by a processor to implement the method of the first aspect.

In a fifth aspect of the present disclosure, a computer program product is provided, comprising computer-executable instructions, where the computer-executable instructions, when executed by a processor, implement the method of the first aspect of the present disclosure.

It should be understood that the content described in this Summary section is neither intended to identify key features or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages, and aspects of the embodiments of the present disclosure will become more apparent in combination with the drawings and with reference to the following detailed description. In the drawings, the same or similar reference numerals represent the same or similar elements.

FIG. 1 shows a schematic diagram of an example environment in which the embodiments may be implemented according to the present disclosure;

FIG. 2 shows a flowchart of an example architecture for video generation according to some embodiments of the present disclosure;

FIG. 3 shows a schematic diagram of an example architecture for video generation according to some other embodiments of the present disclosure;

FIG. 4 shows a schematic diagram of an example architecture of a diffusion model according to some embodiments of the present disclosure;

FIG. 5 shows a schematic diagram of an example architecture of a training process according to some embodiments of the present disclosure;

FIG. 6 shows a schematic diagram of a process of video generation according to some embodiments of the present disclosure;

FIG. 7 shows a schematic structural block diagram of an example apparatus for video generation according to some embodiments of the present disclosure; and

FIG. 8 shows a block diagram of an electronic device capable of implementing a plurality of embodiments of the present disclosure.

### DETAILED DESCRIPTION OF EMBODIMENTS

The embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein. Instead, these embodiments are provided for a more thorough and complete understanding of the present disclosure. It should be understood that the drawings and embodiments of the present disclosure are only used for illustrative purposes, rather than limiting the protection scope of the present disclosure.

In the description of the embodiments of the present disclosure, the term “include/comprise” and similar terms should be understood as open-ended inclusions, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. Other definitions, either explicitly or implicitly, may be included below.

In this paper, unless otherwise explicitly specified, the execution of a step “in response to A” does not mean that the step is executed immediately after “A”, but may include one or more intermediate steps.

It may be understood that the data involved in the technical solution (including but not limited to the data itself, acquisition or use of the data) should comply with requirements of corresponding laws, regulations, and related provisions.

It may be understood that before the use of the technical solution disclosed in the embodiments of the present disclosure, the user should be informed of the type, range of use, use scenarios, etc., of personal information involved in the present disclosure and the authorization of the user should be obtained in an appropriate manner in accordance with relevant laws and regulations.

For example, in response to receiving an active request from a user, prompt information is sent to the user to clearly notify the user that the requested operation will require access to and use of the user's personal information, so that the user may independently choose, based on the prompt information, whether to provide the personal information to software or hardware, such as an electronic device, an application program, a server, or a storage medium, that performs the operations of the technical solution of the present disclosure.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to choose whether to “agree” or “disagree” to provide the personal information to the electronic device.

It may be understood that the above process of notifying and obtaining user authorization is only illustrative and does not limit the implementations of the present disclosure. Other manners that satisfy the relevant laws and regulations may also be applied in the implementations of the present disclosure.

As used herein, the term “model” may learn a correlation between respective inputs and outputs from training data, so that after the completion of training, a corresponding output may be generated for a given input. The generation of the model may be based on machine learning techniques. Deep learning is a machine learning algorithm that uses multiple layers of processing units to process inputs and provide corresponding outputs. A neural network model is an example of a model based on deep learning. Herein, a “model” may also be referred to as a “machine learning model”, a “learning model”, a “machine learning network”, or a “learning network”, which are used interchangeably herein.

A “neural network” is a machine learning network based on deep learning. A neural network may process inputs and provide corresponding outputs, and generally includes an input layer and an output layer, as well as one or more hidden layers between the input layer and the output layer. Neural networks used in deep learning applications typically include many hidden layers, thereby increasing the depth of the network. The layers of the neural network are connected in sequence, so that the output of the previous layer is provided as the input of the next layer. The input layer receives the input of the neural network, and the output of the output layer serves as the final output of the neural network. Each layer of the neural network includes one or more nodes (also referred to as processing nodes or neurons), each of which processes the input from the previous layer.

Generally, machine learning may be roughly divided into three stages, namely, a training stage, a testing stage, and an application stage (also referred to as an inference stage). In the training stage, a given model may be trained using a large amount of training data, and parameter values are continuously updated through iteration, until the model may obtain consistent inference from the training data that satisfies an expected objective. Through training, it may be considered that the model may learn the correlation (also referred to as a mapping from the input to the output) from the input to the output from the training data. The parameter values of the model are determined after training. In the testing stage, a test input is applied to the trained model to test whether the model may provide a correct output, thereby determining the performance of the model. In the application stage, the model may be used to process an actual input based on the parameter values obtained through training, to determine a corresponding output.

As mentioned above, recently, the technology of using machine learning models to generate videos has made great progress, making it possible to synthesize human motion videos from a single image. However, on the one hand, it is usually difficult to accurately control the facial expression and body posture of a person using a single control signal, especially to precisely control subtle facial expressions (such as subtle blinking and lip trembling, etc.). On the other hand, it is difficult for a single control signal to ensure information integrity, resulting in an invisible area (such as the back or side) of the person. In the inference process, as the time scale continues, the model may easily lose the information of the invisible area. This gradual information decay may easily lead to inconsistency in the invisible area in the sequentially generated video. In addition, in the case of multi-scale input, due to the difference in information density and focus priority, it is difficult for the traditional model to ensure the generalization ability for various tasks. For example, it is usually impossible to simultaneously ensure the generation quality of avatar videos, upper body videos, and full body videos.

In view of this, the embodiments of the present disclosure provide an improved solution for video generation. In this solution, an appearance feature representation indicative of an appearance of a target object is determined based on at least one reference image of the target object. A posture feature representation sequence is extracted based on a driving video corresponding to a driving object. The posture feature representation sequence includes a plurality of posture feature representations corresponding to a plurality of video frames in the driving video, where each posture feature representation indicates a body posture of the driving object in a corresponding video frame. A facial state feature representation sequence is extracted based on facial state information indicative of a facial state (e.g., a facial representation, a facial action) of the driving object. The facial state feature representation sequence includes a plurality of facial state feature representations. Then, based on the appearance feature representation, the posture feature representation sequence, and the facial state feature representation sequence, a target video is generated using a trained video generation model. The target video includes the target object, and a body posture and a facial state of the target object in the target video correspond to the driving video and the facial state information, respectively.

In the embodiments of the present disclosure, the appearance of the target object is controlled using the reference image, the body posture is driven using the driving video, and the facial expression is driven using the facial state information. In this way, not only the effective control of subtle facial expressions may be enhanced, but also the control of facial expressions is decoupled from the control of body postures, so that the target object in the generated video (i.e., the target video) may be made more flexible and realistic, which facilitates improving video generation quality.

Various example implementations of this solution are described in detail below with further reference to the drawings.

### Example Environment

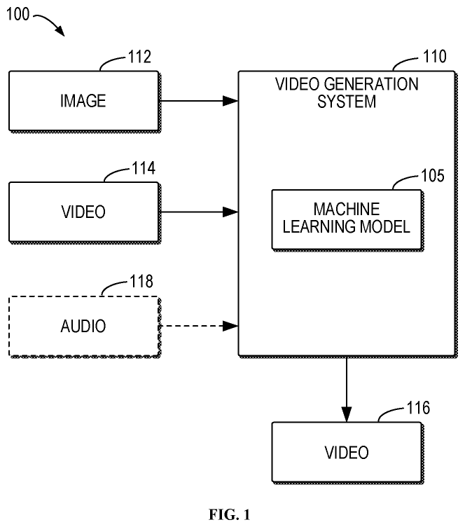

FIG. 1 shows a schematic diagram of an example environment 100 in which the embodiments of the present disclosure may be implemented. In the environment 100 of FIG. 1, a video generation system 110 may use one or more machine learning models 105 to perform video generation. The machine learning model 105 is configured to generate a video 116 (which may also be referred to as a target video) based on an image 112 and a video 114 (which may also be referred to as a driving video).

In some embodiments, the image 112 may also be referred to as a reference image, and the reference image may include an object (for example, a person, a cartoon character, an animal, etc.). The video 114 may also be referred to as a driving video, and the driving video may also include an object (for example, a person, a cartoon character, an animal, etc.). An object in the video 116 may have the same or similar appearance as the object in the reference image, and a facial expression and a body posture of the object in the video 116 corresponds to that of the object in the video 114.

In some embodiments, the video generation system 110 may also use the machine learning model 105 to generate the video 116 based on the image 112, the video 114, and an audio 118. In this case, the facial expression of the object in the video 116 may match the audio 118, and the body posture of the object in the video 116 may correspond to that of the object in the video 114. That is, the facial expression of the target object in the video 116 may be controlled by the video 114 or by the audio 118. Certainly, in an actual application scenario, the expression of the target object in the video may also be controlled by, for example, text or other modal information. This is not limited in the embodiments of the present disclosure.

In some embodiments, the video generation system 110 may be implemented on any computing system with computing power, such as various computing devices/systems, terminal devices, servers, etc. The terminal device may include any type of mobile terminal, fixed terminal, or portable terminal, including a mobile phone, a desktop computer, a laptop computer, a netbook, a tablet computer, a media computer, a multimedia tablet, or any combination thereof, including accessories and peripherals of these devices, or any combination thereof. The server includes, but is not limited to, a mainframe, an edge computing node, a computing device in a cloud environment, etc.

The machine learning model 150 may relates to different types of models. In some embodiments, the one or more machine learning models 150 may include a generative model. In some embodiments, the one or more machine learning models 150 may be constructed based on a diffusion model. The diffusion model, also known as a diffusion probabilistic model, is a class of generative models. The model generates data by simulating a diffusion process. This process is inspired by physical processes such as thermal diffusion. The diffusion model includes a forward diffusion process and a reverse diffusion process. The diffusion model simulates a forward diffusion process of gradually adding noise, and then learns how to reverse this process to generate new data samples.

In the forward diffusion process, noise is gradually added to the data, making the data more and more random through a series of steps, until the data resembles pure noise. This process may be viewed as a Markov chain, in which Gaussian noise is added to the data at each step. The forward diffusion process may be expressed as: q(xₜ|xₜ₋₁)= [symbol] (xₜ;\sqrt{αₜ}xₜ₋₁,(1−αₜ)I), where xₜ is the noise data at the t^{th} step, and αₜ is used to control the amount of added noise. The forward diffusion process is performed during model training, and the data for adding noise is a training sample.

In the reverse diffusion process (or reverse denoising process), the model learns how to reverse the steps of adding noise. Starting from pure noise, the diffusion model gradually removes noise to generate data that matches the training distribution. The reverse diffusion process is typically simulated using a neural network that predicts the noise added at each step: p_{θ}(xₜ₋₁|xₜ)= [symbol] (xₜ₋₁;u_{θ}(xₜ, t),σ_{θ}(xₜ, t)), where u_{θ} and σ_{θ} are the model parameters obtained through learning. After the completion of model training, the model that performs the reverse diffusion process may first sample from a noise distribution, and use the model to iteratively remove noise, until the desired data is obtained.

In the diffusion model, a time step refers to the number of steps for adding noise in the forward diffusion process. The total number of steps T is usually a preset value, which represents how many steps are required for the transformation from the original data to pure noise. At each time step t, Gaussian noise is added to the data according to a predetermined noise scheme. This process is continuous, and each step depends on the result of the previous step.

When generating data, an inference step of the diffusion model refers to the number of steps required to restore from the pure noise to the original data in the reverse diffusion process. The number of inference steps directly affects the quality and speed of the generated data. Generally, the greater the number of inference steps, the higher the quality of the generated data, but this will also increase the computing cost and time. In practical applications, the number of inference steps may be adjusted to balance the generation quality and efficiency. In some embodiments, the inference steps correspond to the time steps, and each inference step may correspond to one or more time steps. For example, if the total number of time steps of the diffusion model is 1000, and the number of inference steps is set to 50, then each inference step may correspond to 20 time steps.

It should be understood that the structure and functions of the environment 100 are described for illustrative purposes only, without suggesting any limitation to the scope of the present disclosure.

### Example Solution

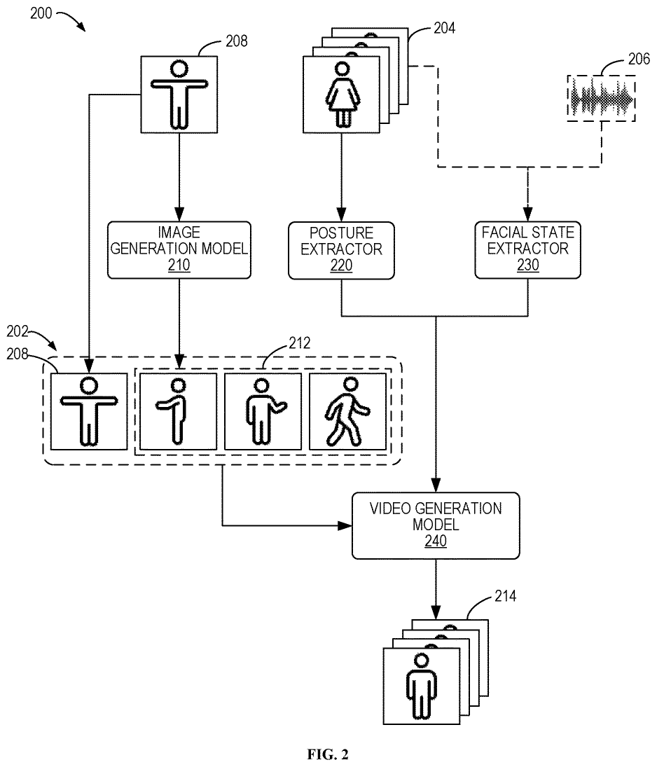

Some example embodiments of the present disclosure are described below with continued reference to the drawings. FIG. 2 shows a schematic diagram of an example architecture 200 for video generation according to some embodiments of the present disclosure. For ease of discussion below, the example architecture 200 is described from the perspective of the video generation system 110, but this is only illustrative.

In some embodiments of the present disclosure, the video generation system 110 may determine, based on at least one reference image 202 of a target object, an appearance feature representation indicative of an appearance of the target object. The target object herein may include, but is not limited to, a person, a cartoon character, an animal, etc. In some embodiments, the at least one reference image 202 may include one reference image or a plurality of reference images. In the case that the at least one reference image 202 includes the plurality of reference images, the target object in the plurality of reference images may have different viewing angles. For example, the target object may be a cartoon character, and the plurality of reference images may include a front-view image, a side-view image, and a back-view image of the cartoon character, etc. Thus, this facilitates increasing information amount of the appearance feature representation, enables the video generation model 240 to obtain appearance information of the target object from different viewing angles, reduce the invisible area, and facilitate improving consistency between video frames in the generated video.

In an actual application scenario, the video generation system 110 may be able to obtain the plurality of reference images that contain the target object from different viewing angles, or may not be able to obtain the plurality of reference images that contain the target object from different viewing angles. In some embodiments, as shown in FIG. 2, if the video generation system 110 obtains a reference image 208 (which may also be referred to as a second reference image herein), the video generation system 110 may generate at least one reference image 212 (which may also be referred to as a third reference image herein) using a trained image generation model 210 based on the reference image 208. A viewing angle of the target object in each reference image 212 is different from a viewing angle of the target object in the reference image 208.

As an example, the reference image 208 may be a front-view image of a target person, and the video generation system 110 may use the image generation model 210 to generate a plurality of reference images 212, which may include a left-side-view image, a back-view image, and a right-side-view image of the target person. As another example, the reference image 208 may include a front upper body image of the target person, and the video generation system 110 may use the reference image 208 to generate a left-side full body image, a right-side full body image, a back full body image, etc., of the target person. In this way, in the case that the plurality of reference images containing the target object from different viewing angles cannot be obtained, the image generation model 210 may be used to generate the plurality of reference images, so that the appearance information of at least a portion of the invisible area of the target object may be supplemented, the difference in the invisible area between the generated video frames may be reduced, which facilitates maintaining the consistency between the video frames in a long time scale.

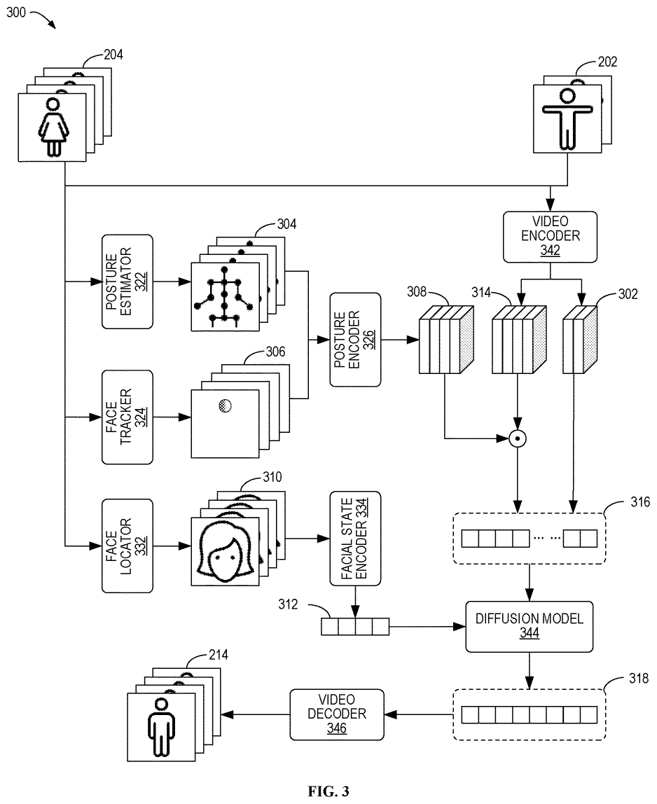

In some examples, FIG. 3 shows a schematic diagram of an example architecture 300 for video generation according to some other embodiments of the present disclosure. As shown in FIG. 3, the video generation model 240 may include a video encoder 342, a diffusion model 344, and a video decoder 346. The video generation system 110 may use the video encoder 342 to perform feature encoding on the at least one reference image 202 to generate an appearance feature representation 302. Certainly, the above manner of extracting the appearance feature representation is only an example, and any other appropriate manner of extracting the appearance feature representation from the reference image may be selected according to the actual need. This is not limited in the embodiments of the present disclosure.

In some embodiments of the present disclosure, referring back to FIG. 2, the video generation system 110 may extract a posture feature representation sequence based on a driving video 204 corresponding to a driving object. The driving object may include a person, a cartoon character, an animal, etc. In some embodiments, the driving object may be different from the target object. For example, the target object may be a cartoon character, and the driving object may be a real person. In this way, the effect of using the body posture of a real person to drive the body posture of a cartoon character may be achieved.

The posture feature representation sequence includes a plurality of posture feature representations corresponding to a plurality of video frames in the driving video, each posture feature representation indicating a body posture of the driving object in a corresponding video frame. In some embodiments, as shown in FIG. 2, the video generation system 110 may use a posture extractor 220 to extract the posture feature representation sequence from the driving video 204.

In some embodiments, each posture feature representation may indicate a head posture and a body posture of the driving object in the corresponding video frame. It should be noted that the body may be understood as including the trunk and limbs herein. The video generation system 110 may extract a body feature and a head feature of the driving object from each of the plurality of video frames. Then, the video generation system 110 may perform feature encoding to obtain the posture feature representation corresponding to each of the plurality of video frames based on the body feature and the head feature that correspond to each of the plurality of video frames. Each body feature may indicate the body posture of the driving object in the corresponding video frame, and each head feature indicates the head posture of the driving object in the corresponding video frame.

In some examples, as shown in FIG. 3, the posture extractor 220 may include a posture estimator 332, a face tracker 324, and a posture encoder 326. The video generation system 110 may use the posture estimator 332 to extract the body feature 304 of the driving object from each video frame in the driving video. The video generation system 110 may also use the face tracker 324 to extract the head feature 306 of the driving object from each video frame in the driving video. Then, the video generation system 110 may use the posture encoder 326 to perform feature encoding on a pair of body feature 304 and head feature 306 corresponding to each video frame, obtaining a posture feature representation corresponding to the corresponding video frame. After completing the feature encoding of the body features 304 and the head features 306 corresponding to the plurality of video frames, the posture feature representation sequence 308 may be obtained.

As an example, the video generation system 110 may cascade the body feature 304 and the head feature 306 along a feature channel dimension to obtain a posture feature. Then, the video generation system 110 may use the posture encoder 326 to perform feature encoding on the posture feature to obtain the posture feature representation.

The process of extracting the body feature and the head feature is illustratively described below with reference to some examples. In some embodiments, for a first video frame of the plurality of video frames, the posture estimator 332 may be used to determine a first skeleton representation corresponding to the driving object in a three-dimensional space corresponding to the first video frame. The first skeleton representation may include a set of predetermined skeleton points of the driving object and a three-dimensional skeleton formed together by lines between some of the set of predetermined skeleton points. The video generation system 110 may use the posture estimator 332 to project the first skeleton representation onto a two-dimensional projection plane to generate a body skeleton representation. The body skeleton representation is to be used as the body feature 304 corresponding to the first video frame. The first video frame may be any one of the plurality of video frames. The two-dimensional projection plane may be an imaging plane corresponding to the first video frame, a plane parallel to the imaging plane, or any other appropriate plane. The body skeleton representation may include a projection pattern formed by the first skeleton representation on the two-dimensional projection plane. Using the body skeleton representation as the body feature 304 may avoid providing too much guidance on the body shape and appearance for the video generation model 240, reduce errors caused by a specific body shape, and enhance the ability of the video generation model 240 to predict different body types and postures, thereby generating a more flexible and realistic video.

In some embodiments, the video generation system 110 may determine a second skeleton representation corresponding to the target object in a three-dimensional space corresponding to a reference image (which may also be referred to as a first reference image herein). The video generation system 110 may also determine a bone proportion between the first skeleton representation and the second skeleton representation, and use the determined bone proportion to correct the first skeleton representation. Then, the corrected first skeleton is projected onto the two-dimensional projection plane to generate the body skeleton representation.

As an example, the video generation system 110 may transform the first skeleton representation and the second skeleton representation into a standard three-dimensional space. Then, in the standard three-dimensional space, a proportion between each bone in the first skeleton representation and the corresponding bone in the second skeleton representation is determined. Each bone length in the first skeleton representation is adjusted according to the determined proportion. In this way, the bone length of the driving object may be aligned with the bone length of the target object, and the body skeleton representation may be used to accurately drive the body posture of the target object, thereby reducing errors.

In some embodiments, for a second video frame of the plurality of video frames, the video generation system 110 may use the face tracker 324 to determine a three-dimensional sphere representation corresponding to a head of the driving object in a three-dimensional space corresponding to the second video frame. Then, the video generation system 110 may use the face tracker 324 to generate, based on a projection of the three-dimensional sphere representation on a two-dimensional projection plane, a head sphere representation as the head feature corresponding to the second video frame. The second video frame here may be any one of the plurality of video frames. The second video frame and the first video frame may be the same video frame or different video frames. The two-dimensional projection plane may be an imaging plane corresponding to the second video frame, a plane parallel to the imaging plane, or any other appropriate plane. By abstracting the complex three-dimensional head posture into a simple and effective two-dimensional representation, the head posture of the target object may be driven flexibly and realistically, and the learning complexity of the video generation model 240 may be significantly reduced. Moreover, this method facilitates preserving the unique head structure of the target object, especially the head structure in the field of animation and cartoon.

In some examples, a trained face tracker 324 may be used to extract three-dimensional face parameters of the driving object from the second video frame. The three-dimensional face parameters may include, but are not limited to, camera parameters and a rotational angular velocity. The video generation system 110 may construct the three-dimensional sphere representation corresponding to the head of the driving object in the three-dimensional space based on the three-dimensional face parameters. The three-dimensional sphere representation may include a three-dimensional sphere structure corresponding to a shape and a size of the head. Then, the video generation system 110 may project the three-dimensional sphere structure onto the two-dimensional projection plane to generate the head sphere representation.

In some examples, the head sphere representation includes a projection pattern of the three-dimensional sphere representation on the two-dimensional projection plane. A position of the projection pattern in the head sphere representation indicates a position of the head of the driving object in the corresponding video frame, and a color of the projection pattern indicates an orientation of the head of the driving object in the corresponding video frame. As an example, the projection pattern may be configured to use a first color (for example, green) to indicate a front side of the head, and use a second color (for example, blue) to indicate a back side of the head. The video generation system 110 may determine a color of each area in the projection pattern based on the orientation of the head of the driving object.

In some examples, the video generation system 110 may correct the three-dimensional sphere representation of the driving object based on the head size of the target object. The corrected three-dimensional sphere representation is projected onto the two-dimensional projection plane to form the head sphere representation. In this way, the head size of the driving object may be aligned with the head size of the target object, and the head posture of the target object may be accurately driven, thereby facilitating reducing errors. It should be noted that the above process of extracting the posture feature representation sequence is only illustrative, and in actual applications, any appropriate manner of extracting the posture feature representation sequence may be selected according to the actual need. This is not limited in the embodiments of the present disclosure.

In some embodiments of the present disclosure, the video generation system 110 may extract a facial state feature representation sequence based on facial state information indicative of a facial state of the driving object. The facial state feature representation sequence includes a plurality of facial state feature representations. In some embodiments, the facial state may include a facial expression state of the driving object, and the facial state information may indicate a facial expression of the driving object. By decoupling the control of the facial expression and the control of the head posture, the generated video may be more flexible and realistic.

In some embodiments, as shown in FIG. 2, the facial state information may include an audio 206. The video generation system 110 may use a facial state extractor 230 to extract the facial state feature representation sequence from the audio 206. As an example, the facial state extractor 230 may include a trained audio encoder. The video generation system 110 may use the audio encoder to perform feature encoding on the audio 206 to generate the facial state feature representation sequence.

In some embodiments, as shown in FIG. 3, the facial state information may include a plurality of frame segments 310 of the head of the driving object extracted from the driving video. The facial state extractor 230 may include a face locator 332 and a facial state encoder 334. The video generation system 110 may use the face locator 332 to extract the plurality of frame segments 310 of the head of the driving object from the driving video. Then, the facial state encoder 334 may be used to perform feature encoding on the plurality of frame segments 310 to generate a facial state feature representation sequence 312. It should be understood that the above facial state information is only illustrative, and any other appropriate information may be selected to drive the facial expression of the target object according to the actual need. This is not specifically limited in the embodiments of the present disclosure. It should also be noted that the facial state encoder 334 for performing feature encoding on the frame segments is different from the audio encoder for performing feature encoding on the audio.

In some embodiments of the present disclosure, referring back to FIG. 2, the video generation system 110 may generate a target video 214 using the trained video generation model 240 based on the appearance feature representation, the posture feature representation sequence, and the facial state feature representation sequence. The target video includes the target object, and the body posture and the facial state of the target object in the target video correspond to the driving video and the facial state information, respectively. For example, the target object in the reference image may be a cartoon character, and the driving object in the driving video may be a real person. The generated target video may include the cartoon character, but the body posture and facial expression of the cartoon character may be similar to those of the real person.

In some embodiments, as shown in FIG. 3, the video generation model 240 may include a video encoder 342, a diffusion model 344, and a video decoder 346. The video generation system 110 may use the video encoder 342 to extract a video frame feature representation sequence 314 from the driving video 204, the video frame feature representation sequence 314 including a plurality of video frame feature representations corresponding to the plurality of video frames. The video generation system 110 may generate an output feature representation sequence 318 using the trained diffusion model 344 based on the appearance feature representation 302, the video frame feature representation sequence 314, the posture feature representation sequence 308, and the facial state feature representation sequence 312. Then, the video generation system 110 may obtain the target video 214 by decoding from the output feature representation sequence 318 using the video decoder 346.

In some examples, the video generation system 110 may obtain a cascaded feature representation sequence based on a cascade of the posture feature representation sequence 308 and the video frame feature representation sequence. The video generation system 110 may also cascade the cascaded feature representation sequence with the appearance feature representation 302 to obtain an input feature representation sequence 316 of the diffusion model 344. The diffusion model 344 may generate the output feature representation sequence 318 based on the input feature representation sequence 316 and the facial state feature representation sequence 312.

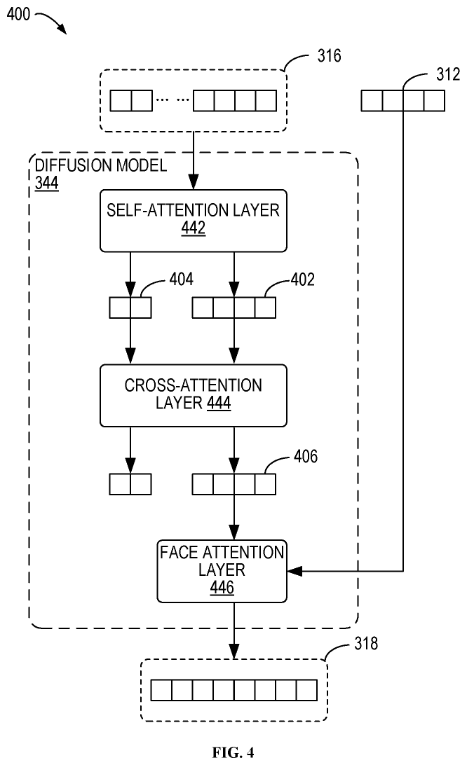

In some embodiments, FIG. 4 shows a schematic diagram of an example structure 400 of the diffusion model 344 according to some embodiments of the present disclosure. As shown in FIG. 4, the diffusion model 344 includes at least a self-attention layer 442, a cross-attention layer 444, and a face attention layer 446. The video generation system 110 may perform, using the self-attention layer 442, self-attention processing based on the input feature representation sequence 316 (which may be expressed as, for example, T∈ [symbol] ^{(t×h×w)×c}) to generate a first intermediate feature representation sequence 402 (which may be expressed as, for example, T_{D}∈ [symbol] ^{t}^{_{D}}^{×(h×w)×c}) and a second intermediate feature representation sequence 404 (which may be expressed as, for example, T_{R}∈ [symbol] ^{t}^{_{R}}^{×(h×w)×c}). The video generation system 110 performs, using the cross-attention layer 444, cross-attention processing on the first intermediate feature representation sequence 402 and the second intermediate feature representation sequence 404 to generate a third intermediate feature representation sequence 406 (which may be expressed as, for example, T_{R}∈ [symbol] ^{t}^{_{R}}^{×(h×w)×c}) and a fourth intermediate feature representation sequence 408 (which may be expressed as, for example, T_{R}∈ [symbol] ^{1×(h×w×t}^{_{R}}^{)×c}). Then, the video generation system 110 may perform, using the face attention layer 446, cross-attention processing based on the third intermediate feature representation sequence 406 and the facial state feature representation sequence 312 to generate the output feature representation sequence 318. In this way, information interaction between information related to the reference image and information related to the driving video may be promoted, thereby facilitating improving the video generation quality.

The foregoing describes the inference process of video generation. In the embodiments of the present disclosure, the control of the facial state, the body posture, and the head posture are decoupled. The robust representation of the facial state, the body posture, and the head posture may be achieved through the facial state information, the body feature (for example, the body skeleton representation), and the head feature (for example, the head sphere representation), so that the generated video is more realistic and flexible. In addition, in the embodiments of the present disclosure, the image generation model 210 may also be used to supplementally generate the reference image, so as to supplement the appearance information of the target object, reduce the invisible area of the target object, and facilitate maintaining the consistency of appearance details in a long time scale.

The following will briefly describe the training process of the video generation model 240, the posture encoder 326, and the facial state encoder 334. In view of the similarity of the data processing process between the training process and the inference process, for the content not described below, reference may be made to the foregoing description of the inference process. It should be understood that such a training process may be performed by an appropriate training system, which may include but is not limited to the video generation system 110.

In some embodiments of the present disclosure, the training process of the video generation model 240 may include a first training stage, a second training stage, and a third training stage. In the first training stage, the video generation model 240 and the posture encoder 326 may be trained by the training system, and the posture encoder 326 may be trained to extract the posture feature representation sequence from the driving video. In the first training stage, by excluding the facial state encoder 334, it may be avoided that an overly complex input hinders the learning model of the video generation model 240. This facilitates the gradual transition of the pre-trained model to the video generation task, and facilitates improving the understanding ability of the video generation model 240 on the video generation task.

In the second training stage, the video generation model 240 and the facial state encoder 334 may be trained by the training system, and the facial state encoder 334 may be trained to extract the facial state feature representation sequence from the facial state information. Specifically, in the second training stage, the focus will be on training the video generation model 240 to express complex facial expressions. In some embodiments, the training system may choose to freeze the self-attention layer 442 and the cross-attention layer 444 in the posture encoder 326 and the diffusion model 344. In the second training stage, the training system may focus on training the facial state encoder 344 and the face attention layer 446 to avoid interference from other variables.

In the third training stage, the video generation model, the posture encoder, and the facial state encoder are jointly trained to jointly optimize all components to fine-tune video generation performance. Therefore, a robust and stable training process may be formed, which is beneficial for forming an efficient video generation model 240 with high adaptability, so that the video generation model 240 may adapt to multi-scale video generation tasks.

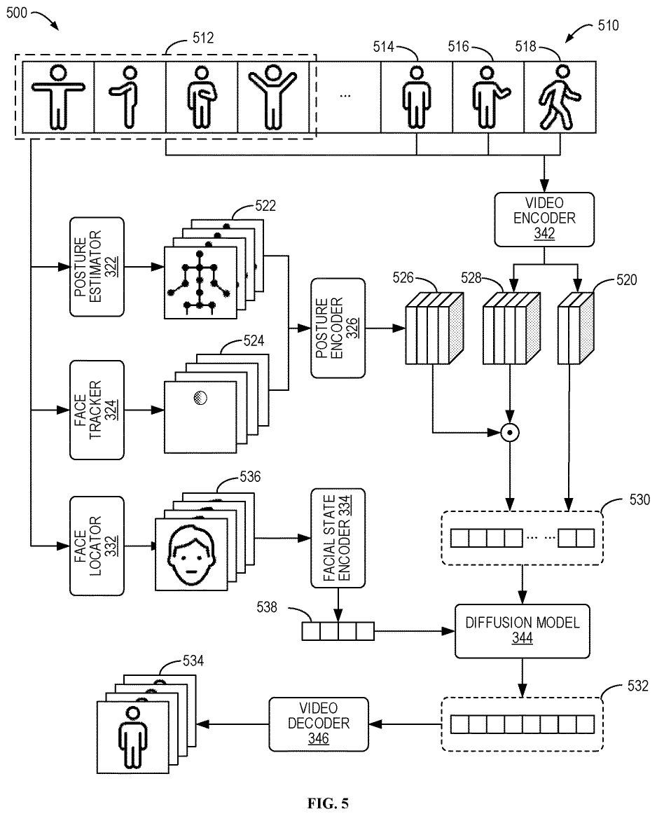

The first training stage is described below with reference to FIG. 5. It should be understood that this is only illustrative. In an actual training process, any appropriate manner of training the video generation model 240 and the posture encoder 326 may be selected.

In some embodiments of the present disclosure, the training system may select a plurality of sample driving frames 512 and at least one sample reference frame from a sample video 510 of a sample object. In some embodiments, the training system may select a plurality of sample reference frames in different viewing angles of the target object. As an example, the training system may determine a rotation angle of the sample object in each sample frame in the sample video, for example, determining a rotation value of the sample object in a Z-axis direction (that is, a vertical direction). The training system may sort the plurality of sample frames based on the rotation angle. Then, the training system may select, from the sorted sample frames, a sample frame 514 with a smallest rotation angle, a sample frame 516 with a largest rotation angle, and a sample frame 518 with a median rotation angle, to obtain the plurality of sample reference frames. As another example, the training system may further select one frame from the sample reference frames 514, 516, and 518, and crop it into a half-body image of the sample object as the sample reference frame, to enrich the understanding of the video generation model to global and local details.

In some embodiments of the present disclosure, the training system determines a sample appearance feature representation indicative of an appearance of the sample object based on the plurality of sample reference frames. As an example, the training system may use the video encoder 342 to perform feature encoding on the plurality of sample reference frames 514, 516, and 518 to generate a sample appearance feature representation 520.

In some embodiments of the present disclosure, the training system may extract a plurality of sample body features 522 and a plurality of sample head features 524 of the sample object from the plurality of sample driving frames 512. Each sample body feature 522 indicates the body posture of the sample object in a corresponding sample driving frame 512, and each sample head feature 524 indicates a head posture of the sample object in the corresponding sample driving frame 512. As an example, the training system may use the trained posture estimator 322 to extract a sample body skeleton representation of the sample object from the sample driving frame 512 as the sample body feature 522. The training system may also use the trained face tracker 324 to extract a sample head sphere representation of the sample object from the sample driving frame 512 as a sample head posture feature 524.

In some embodiments of the present disclosure, the training system may use a posture encoder 526 to be trained to perform feature encoding on the sample body features 522 and the sample head features 524 that correspond to the plurality of sample driving frames, respectively, to generate a sample posture feature representation sequence 526. The training system may also use the video encoder 342 to perform feature encoding on the plurality of sample driving frames to obtain a sample video frame feature representation sequence 528. The training system may cascade the sample appearance feature representation 520, the sample video frame feature representation sequence 528, and the sample posture feature representation sequence 526 to obtain a sample input feature representation sequence 530.

In some embodiments of the present disclosure, the training system may generate a sample output feature representation sequence 532 using the diffusion model 344 to be trained based on the sample input feature representation sequence 530. The training system may use the video decoder 346 to decode a predicted video 534 from the sample output feature representation sequence 532. Then, the training system may update the posture encoder 326 and the video generation model 240 based on a difference between the sample video 510 and the predicted video 534.

The following continues to describe, with reference to FIG. 5, processes in the second training stage and the third training stage that are different from the first training stage. The processes that are the same as those in the first stage are not described or briefly described below. Reference may be made to the foregoing description of the first training stage.

In the second training stage, the training system may freeze the parameters of the posture encoder 326 trained in the first training stage, and the training system may also freeze the parameters of the self-attention layer 442 and the cross-attention layer 444 in the diffusion model 344. The training system may also use the trained face locator 332 to extract a plurality of sample frame segments 536 of the head of the sample object from the plurality of sample driving frames 512. The training system may use the facial state encoder 334 to be trained to perform feature encoding on the plurality of sample frame segments 536 to obtain a sample facial state feature representation sequence 538. The training system may provide the sample facial state feature representation sequence 538 to the face attention layer 446 of the diffusion model, and use the face attention layer 446 to perform cross-attention processing on the sample facial state feature representation sequence 538 and the intermediate feature representation sequence output by the cross-attention layer 444 to generate the sample output feature representation sequence 532. The training system may use the video decoder to decode the predicted video 534 from the sample output feature representation sequence 532. Then, the training system may update the parameters of the facial state encoder 334 and the face attention layer 446 based on the difference between the sample video 510 and the predicted video 534.

In the third training stage, the training device may unfreeze the parameters of the posture encoder 326, and the training device may also unfreeze the parameters of the self-attention layer 442 and the cross-attention layer 444 of the diffusion model 344. In the third training stage, the training device may repeat the process in the second training stage to obtain the predicted video 534. Different from the second training stage, the training device may update the parameters of the posture encoder 326, the facial state encoder 334, and the video generation model 240 based on the difference between the sample video 510 and the predicted video 534, to jointly train the posture encoder 326, the facial state encoder 334, and the video generation model 240.

In some embodiments, the audio encoder for extracting the facial state feature representation sequence from the audio may be trained separately. Specifically, the training device may obtain a sample video and a sample audio corresponding to the sample video. The training device may use, for example, a face locator 332 to extract a plurality of sample frame segments 536 of the sample object from the sample video. The training system may use the trained facial state encoder 334 to perform feature encoding on the plurality of sample frame segments 536 to generate a ground-truth facial state feature representation sequence. The training system may also use the audio encoder to be trained to perform feature encoding on the sample audio to generate a predicted facial state feature representation sequence. The training system may update the audio encoder based on a difference between the ground-truth facial state feature representation sequence and the predicted facial state feature representation sequence, to train the audio encoder.

In this way, in the embodiments of the present disclosure, a robust and stable training process may be formed, which is beneficial for forming an efficient video generation model 240 with high adaptability, so that the video generation model 240 may adapt to multi-scale video generation tasks.

### Example Process, Apparatus, and Device

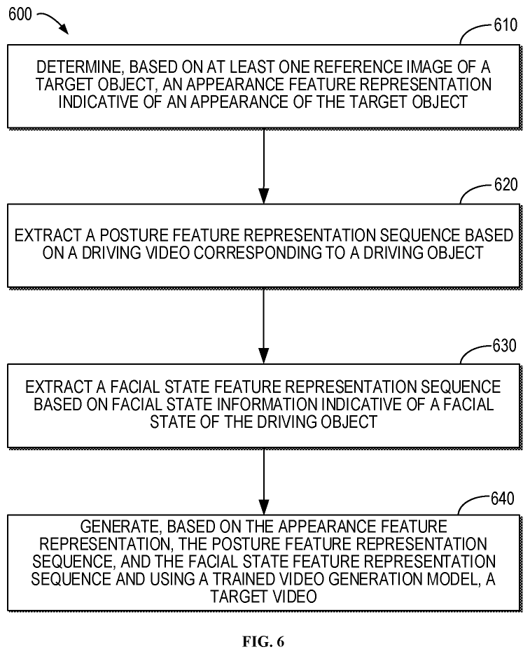

FIG. 6 shows a flowchart of a process 600 of video generation according to some embodiments of the present disclosure. In the following, for ease of discussion, the process 600 is described from the perspective of the video generation system 110, but this is only illustrative.

At block 610, the video generation system 110 determines, based on at least one reference image of a target object, an appearance feature representation indicative of an appearance of the target object.

At block 620, the video generation system 110 extracts, based on a driving video corresponding to a driving object, a posture feature representation sequence, the posture feature representation sequence including a plurality of posture feature representations corresponding to a plurality of video frames in the driving video, each posture feature representation indicative of a body posture of the driving object in a corresponding video frame.

At block 630, the video generation system 110 extracts, based on facial state information indicative of a facial state of the driving object, a facial state feature representation sequence, the facial state feature representation sequence including a plurality of facial state feature representations.

At block 640, the video generation system 110 generates, based on the appearance feature representation, the posture feature representation sequence, and the facial state feature representation sequence and using a trained video generation model, a target video, the target video including the target object, and a body posture and a facial state of the target object in the target video corresponding to the driving video and the facial state information, respectively.

In some embodiments, extracting the posture feature representation sequence includes: extracting a body feature and a head feature of the driving object from a video frame of the plurality of video frames, each body feature indicative of a body posture of the driving object in a corresponding video frame, and each head feature indicative of a head posture of the driving object in a corresponding video frame; and obtaining the posture feature representation corresponding to each of the plurality of video frames based on performing feature encoding on the body feature and the head feature that correspond to each of the plurality of video frames.

In some embodiments, extracting the body feature includes: determining, for a first video frame of the plurality of video frames, a first skeleton representation corresponding to the driving object in a three-dimensional space corresponding to the first video frame; and generating a body skeleton representation that is to be used as the body feature corresponding to the first video frame by projecting the first skeleton representation onto a two-dimensional projection plane.

In some embodiments, generating the body skeleton representation includes: determining, based on a first reference image of the at least one reference image, a second skeleton representation corresponding to the target object in a three-dimensional space corresponding to the first reference image; correcting the first skeleton representation based on a bone proportion between the first skeleton representation and the second skeleton representation; and projecting the corrected first skeleton onto the two-dimensional projection plane to generate the body skeleton representation.

In some embodiments, extracting the head feature includes: determining, for a second video frame of the plurality of video frames, a three-dimensional sphere representation corresponding to a head of the driving object in a three-dimensional space corresponding to the second video frame; and generating a head sphere representation that is to be used as the head feature corresponding to the second video frame based on a projection of the three-dimensional sphere representation on a two-dimensional projection plane.

In some embodiments, the head sphere representation includes a projection pattern of the three-dimensional sphere representation on the two-dimensional projection plane, a position of the projection pattern in the head sphere representation indicative of a position of the head of the driving object in the corresponding video frame, and a color of the projection pattern indicative of an orientation of the head of the driving object in the corresponding video frame.

In some embodiments, the at least one reference image includes a second reference image, and determining the appearance feature representation includes: generating, based on the second reference image and using a trained image generation model, at least one third reference image, a viewing angle of the target object in the second reference image being different from a viewing angle of the target object in a third reference image of the at least one third reference image; and determining, based on the second reference image and the at least one third reference image, the appearance feature representation indicative of the appearance of the target object.

In some embodiments, the facial state information includes at least one of: a plurality of frame segments of a head of the driving object extracted from the driving video, or an audio.

In some embodiments, extracting the facial state feature representation sequence includes one of: performing, using a trained facial state encoder, feature encoding on the plurality of frame segments to determine the facial state feature representation sequence, or performing, using a trained audio encoder, feature encoding on the audio to determine the facial state feature representation sequence.

In some embodiments, the video generation model includes a video encoder, a diffusion model, and a video decoder, and generating the target video includes: extracting, using the video encoder, a video frame feature representation sequence from the driving video, the video frame feature representation sequence including a plurality of video frame feature representations corresponding to the plurality of video frames; generating, based on the appearance feature representation, the video frame feature representation sequence, the posture feature representation sequence, and the facial state feature representation sequence and using the trained diffusion model, an output feature representation sequence; and obtaining the target video by decoding from the output feature representation sequence using the video decoder.

In some embodiments, the diffusion model includes at least a self-attention layer, a cross-attention layer, and a face attention layer, and generating the output feature representation sequence includes: performing, based on the appearance feature representation, the video frame feature representation sequence, and the posture feature representation sequence and using the self-attention layer, self-attention processing to generate a first intermediate feature representation sequence and a second intermediate feature representation sequence; performing, based on the first intermediate feature representation sequence and the second intermediate feature representation sequence and using the cross-attention layer, cross-attention processing to generate a third intermediate feature representation sequence; and performing, based on the third intermediate feature representation sequence and the facial state feature representation sequence and using the face attention layer, cross-attention processing to generate the output feature representation sequence.

In some embodiments, a training process of the video generation model includes: a first training stage, in which the video generation model and a posture encoder are trained, the posture encoder being trained to extract the posture feature representation sequence from the driving video; a second training stage, in which the video generation model and a facial state encoder are trained, the facial state encoder being trained to extract the facial state feature representation sequence from the facial state information; and a third training stage, in which the video generation model, the posture encoder, and the facial state encoder are jointly trained.

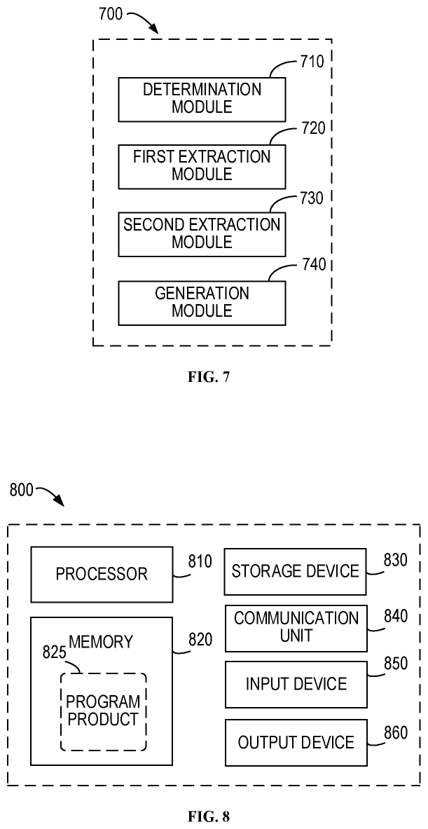

The embodiments of the present disclosure further provide a corresponding apparatus for implementing the above method or process. FIG. 7 shows a schematic structural block diagram of an example apparatus 700 for video generation according to some embodiments of the present disclosure. The apparatus 700 may be implemented as or included in the video generation system 110. Each module/component in the apparatus 700 may be implemented by hardware, software, firmware, or any combination thereof.

As shown in FIG. 7, the apparatus 700 includes: a determination module 710 configured to determine, based on at least one reference image of a target object, an appearance feature representation indicative of an appearance of the target object; a first extraction module 720 configured to extract, based on a driving video corresponding to a driving object, a posture feature representation sequence, the posture feature representation sequence including a plurality of posture feature representations corresponding to a plurality of video frames in the driving video, each posture feature representation indicative of a body posture of the driving object in a corresponding video frame; a second extraction module 730 configured to extract, based on facial state information indicative of a facial state of the driving object, a facial state feature representation sequence, the facial state feature representation sequence including a plurality of facial state feature representations; and a generation module 740 configured to generate, based on the appearance feature representation, the posture feature representation sequence, and the facial state feature representation sequence and using a trained video generation model, a target video, the target video including the target object, and a body posture and a facial state of the target object in the target video corresponding to the driving video and the facial state information, respectively.

In some embodiments, the first extraction module 720 is further configured to: extract a body feature and a head feature of the driving object from a video frame of the plurality of video frames, each body feature indicative of a body posture of the driving object in a corresponding video frame, and each head feature indicative of a head posture of the driving object in a corresponding video frame; and obtain the posture feature representation corresponding to each of the plurality of video frames based on performing feature encoding on the body feature and the head feature that correspond to each of the plurality of video frames.

In some embodiments, the first extraction module 720 is further configured to: determine, for a first video frame of the plurality of video frames, a first skeleton representation corresponding to the driving object in a three-dimensional space corresponding to the first video frame; and generate a body skeleton representation that is to be used as the body feature corresponding to the first video frame by projecting the first skeleton representation onto a two-dimensional projection plane.

In some embodiments, the first extraction module 720 is further configured to: determine, based on a first reference image of the at least one reference image, a second skeleton representation corresponding to the target object in a three-dimensional space corresponding to the first reference image; correct the first skeleton representation based on a bone proportion between the first skeleton representation and the second skeleton representation; and project the corrected first skeleton onto the two-dimensional projection plane to generate the body skeleton representation.

In some embodiments, the first extraction module 720 is further configured to: determine, for a second video frame of the plurality of video frames, a three-dimensional sphere representation corresponding to a head of the driving object in a three-dimensional space corresponding to the second video frame; and generate a head sphere representation that is to be used as the head feature corresponding to the second video frame based on a projection of the three-dimensional sphere representation on a two-dimensional projection plane.

In some embodiments, the head sphere representation includes a projection pattern of the three-dimensional sphere representation on the two-dimensional projection plane, a position of the projection pattern in the head sphere representation indicative of a position of the head of the driving object in the corresponding video frame, and a color of the projection pattern indicative of an orientation of the head of the driving object in the corresponding video frame.

In some embodiments, the at least one reference image includes a second reference image, and the determination module 710 is further configured to: generate, based on the second reference image and using a trained image generation model, at least one third reference image, a viewing angle of the target object in the second reference image being different from a viewing angle of the target object in a third reference image of the at least one third reference image; and determine, based on the second reference image and the at least one third reference image, the appearance feature representation indicative of the appearance of the target object.

In some embodiments, the facial state information includes at least one of: a plurality of frame segments of a head of the driving object extracted from the driving video, or an audio.

In some embodiments, the second extraction module 730 is further configured to: perform, using a trained facial state encoder, feature encoding on the plurality of frame segments to determine the facial state feature representation sequence, or perform, using a trained audio encoder, feature encoding on the audio to determine the facial state feature representation sequence.

In some embodiments, the video generation model includes a video encoder, a diffusion model, and a video decoder, and the generation module 740 is further configured to: extract, using the video encoder, a video frame feature representation sequence from the driving video, the video frame feature representation sequence including a plurality of video frame feature representations corresponding to the plurality of video frames; generate, based on the appearance feature representation, the video frame feature representation sequence, the posture feature representation sequence, and the facial state feature representation sequence and using the trained diffusion model, an output feature representation sequence; and obtain the target video by decoding from the output feature representation sequence using the video decoder.

In some embodiments, the diffusion model includes at least a self-attention layer, a cross-attention layer, and a face attention layer, and the generation module 740 is further configured to: perform, based on the appearance feature representation, the video frame feature representation sequence, and the posture feature representation sequence and using the self-attention layer, self-attention processing to generate a first intermediate feature representation sequence and a second intermediate feature representation sequence; perform, based on the first intermediate feature representation sequence and the second intermediate feature representation sequence and using the cross-attention layer, cross-attention processing to generate a third intermediate feature representation sequence; and perform, based on the third intermediate feature representation sequence and the facial state feature representation sequence and using the face attention layer, cross-attention processing to generate the output feature representation sequence.

In some embodiments, a training process of the video generation model includes: a first training stage, in which the video generation model and a posture encoder are trained, the posture encoder being trained to extract the posture feature representation sequence from the driving video; a second training stage, in which the video generation model and a facial state encoder are trained, the facial state encoder being trained to extract the facial state feature representation sequence from the facial state information; and a third training stage, in which the video generation model, the posture encoder, and the facial state encoder are jointly trained.

The units and/or modules included in the apparatus 700 may be implemented in various ways, including software, hardware, firmware, or any combination thereof. In some embodiments, one or more units and/or modules may be implemented using software and/or firmware, such as machine-executable instructions stored on a storage medium. In addition to machine-executable instructions or as an alternative, some or all units and/or modules in the apparatus 700 may be implemented at least partially by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logic device (CPLD), and the like.

FIG. 8 shows a block diagram of an electronic device 800 in which one or more embodiments of the present disclosure may be implemented. It should be understood that the electronic device 800 shown in FIG. 8 is only illustrative and should not constitute any limitation on the functionality and scope of the embodiments described herein. The electronic device 800 shown in FIG. 8 may include or be implemented as the video generation system 110 in FIG. 1 or the apparatus 700 in FIG. 7.

As shown in FIG. 8, the electronic device 800 is in the form of a general electronic device. The components of electronic device 800 may include, but are not limited to, one or more processors or processors 810, a memory 820, a storage device 830, one or more communication units 840, one or more input devices 850, and one or more output devices 860. The processor 810 may be an actual or virtual processor and may execute various processes according to the executable instructions stored in the memory 820. In a multi-processor system, multiple processors execute computer-executable instructions in parallel to improve the parallel processing capability of the electronic device 800.

The electronic device 800 typically includes multiple computer storage medium. Such medium may be any available medium that is accessible to the electronic device 800, including, but not limited to, volatile and non-volatile medium, removable and non-removable medium. The memory 820 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 830 may be a removable or non-removable medium, and may include a machine-readable medium such as a flash drive, a disk, or any other medium, which may be used to store information and/or data and may be accessed within the electronic device 800.

The electronic device 800 may further include other removable/non-removable, volatile/non-volatile memory medium. Although not shown in FIG. 8, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 820 may include a computer program product 825, which has one or more executable instruction modules configured to perform various methods or acts of the various embodiments of the present disclosure.

The communication unit 840 implements communication with other electronic devices through the communication medium. In addition, the functions of the components of the electronic device 800 may be implemented by a single computing cluster or multiple computing machines, which may communicate through communication connections. Therefore, the electronic device 800 may use a logical connection with one or more other servers, a network personal computer (PC), or another network node to operate in a networked environment.

The input device 850 may be one or more input devices, such as a mouse, a keyboard, a tracking ball, etc. The output device 860 may be one or more output devices, such as a display, a speaker, a printer, etc. The electronic device 800 may also communicate with one or more external devices (not shown) as needed through the communication unit 840 (such as a storage device, a display device, etc.), communicate with one or more devices that enable a user to interact with the electronic device 800, or communicate with any device (e.g., a network card, a modem, etc.) that enables the electronic device 800 to communicate with one or more other electronic devices. Such communication may be performed via input/output (I/O) interfaces (not shown).

According to an example implementation of the present disclosure, a computer-readable storage medium is provided, having computer-executable instructions stored thereon, where the computer-executable instructions are executed by a processor to implement the method described above. According to an example implementation of the present disclosure, there is further provided a computer-executable instruction product, the computer-executable instruction product being tangibly stored on a non-transitory computer-readable medium and including computer-executable instructions, the computer-executable instructions being executed by a processor to implement the method described above.

Various aspects of the present disclosure are described herein with reference to flowcharts and/or block diagrams of methods, apparatuses, devices, and computer-executable instruction products implemented according to the present disclosure. It should be understood that each block in the flowchart and/or block diagram, and combinations of blocks in the flowchart and/or block diagram, may be implemented by computer-readable executable instructions.

These computer-executable instructions may be provided to a processor of a general-purpose computer, a special-purpose computer, or other programmable data processing apparatus, to produce a machine, such that when these instructions are executed by the processor of the computer or other programmable data processing apparatus, an apparatus that implements the functions/acts specified in one or more blocks in the flowchart and/or block diagram is produced. These computer-executable instructions may also be stored in a computer-readable storage medium, these instructions cause the computer, the programmable data processing apparatus, and/or other devices to work in a specific manner, so that the computer-readable medium storing the instructions includes a manufactured product, which includes instructions for implementing various aspects of the functions/acts specified in one or more blocks in the flowchart and/or block diagram.

The computer-executable instructions may be loaded onto a computer, other programmable data processing apparatus, or other devices, to perform a series of operation steps on the computer, other programmable data processing apparatus, or other devices, to produce a computer-implemented process, so that the instructions executed on the computer, other programmable data processing apparatus, or other devices implement the functions/acts specified in one or more blocks in the flowchart and/or block diagram.

The flowchart and block diagram in the drawings show the possibly implemented architectures, functions, and operations of the system, the method, and the computer-executable instruction product according to multiple implementations of the present disclosure. In this regard, each block in the flowchart or block diagram may represent a module, an executable instruction or a part of the instruction, and the module, the executable instruction or the part of the instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and a combination of blocks in the block diagram and/or the flowchart may be implemented by a special-purpose hardware-based system that executes specified functions or acts, or by a combination of special-purpose hardware and computer instructions.

The implementations of the present disclosure have been described above. The above description is illustrative, non-exhaustive, and is not limited to the disclosed implementations. Without departing from the scope and spirit of the described implementations, many modifications and changes will be apparent to those of ordinary skill in the art. The choice of terms used herein is intended to best explain the principles, practical applications, or improvements to the technology in the market of each implementation, or to enable other ordinary technicians in the technical field to understand the various implementations disclosed herein.

1. A video generation method, comprising:
determining, based on at least one reference image of a target object, an appearance feature representation indicative of an appearance of the target object;
extracting, based on a driving video corresponding to a driving object, a posture feature representation sequence, the posture feature representation sequence comprising a plurality of posture feature representations corresponding to a plurality of video frames in the driving video, each posture feature representation indicative of a body posture of the driving object in a corresponding video frame;
extracting, based on facial state information indicative of a facial state of the driving object, a facial state feature representation sequence, the facial state feature representation sequence comprising a plurality of facial state feature representations; and
generating, based on the appearance feature representation, the posture feature representation sequence, and the facial state feature representation sequence and using a trained video generation model, a target video, the target video comprising the target object, and a body posture and a facial state of the target object in the target video corresponding to the driving video and the facial state information, respectively.

2. The method of claim 1, wherein extracting the posture feature representation sequence comprises:
extracting a body feature and a head feature of the driving object from a video frame of the plurality of video frames, each body feature indicative of a body posture of the driving object in a corresponding video frame, and each head feature indicative of a head posture of the driving object in a corresponding video frame; and
obtaining the posture feature representation corresponding to each of the plurality of video frames based on performing feature encoding on the body feature and the head feature that correspond to each of the plurality of video frames.

3. The method of claim 2, wherein extracting the body feature comprises: for a first video frame of the plurality of video frames,
determining a first skeleton representation corresponding to the driving object in a three-dimensional space corresponding to the first video frame; and
generating a body skeleton representation that is to be used as the body feature corresponding to the first video frame by projecting the first skeleton representation onto a two-dimensional projection plane.

4. The method of claim 3, wherein generating the body skeleton representation comprises:
determining, based on a first reference image of the at least one reference image, a second skeleton representation corresponding to the target object in a three-dimensional space corresponding to the first reference image;
correcting the first skeleton representation based on a bone proportion between the first skeleton representation and the second skeleton representation; and
projecting the corrected first skeleton onto the two-dimensional projection plane to generate the body skeleton representation.

5. The method of claim 2, wherein extracting the head feature comprises: for a second video frame of the plurality of video frames,
determining a three-dimensional sphere representation corresponding to a head of the driving object in a three-dimensional space corresponding to the second video frame; and
generating a head sphere representation that is to be used as the head feature corresponding to the second video frame based on a projection of the three-dimensional sphere representation on a two-dimensional projection plane.

6. The method of claim 5, wherein the head sphere representation comprises a projection pattern of the three-dimensional sphere representation on the two-dimensional projection plane, a position of the projection pattern in the head sphere representation indicative of a position of the head of the driving object in the corresponding video frame, and a color of the projection pattern indicative of an orientation of the head of the driving object in the corresponding video frame.

7. The method of claim 1, wherein the at least one reference image comprises a second reference image, and determining the appearance feature representation comprises:
generating, based on the second reference image and using a trained image generation model, at least one third reference image, a viewing angle of the target object in the second reference image being different from a viewing angle of the target object in a third reference image of the at least one third reference image; and
determining, based on the second reference image and the at least one third reference image, the appearance feature representation indicative of the appearance of the target object.

8. The method of claim 1, wherein the facial state information comprises at least one of:
a plurality of frame segments of a head of the driving object extracted from the driving video, or
an audio.

9. The method of claim 8, wherein extracting the facial state feature representation sequence comprises one of:
performing, using a trained facial state encoder, feature encoding on the plurality of frame segments to determine the facial state feature representation sequence, or
performing, using a trained audio encoder, feature encoding on the audio to determine the facial state feature representation sequence.

10. The method of claim 1, wherein the video generation model comprises a video encoder, a diffusion model, and a video decoder, and generating the target video comprises:
extracting, using the video encoder, a video frame feature representation sequence from the driving video, the video frame feature representation sequence comprising a plurality of video frame feature representations corresponding to the plurality of video frames;
generating, based on the appearance feature representation, the video frame feature representation sequence, the posture feature representation sequence, and the facial state feature representation sequence and using a trained diffusion model, an output feature representation sequence; and
obtaining the target video by decoding from the output feature representation sequence using the video decoder.

11. The method of claim 10, wherein the diffusion model comprises at least a self-attention layer, a cross-attention layer, and a face attention layer, and generating the output feature representation sequence comprises:
performing, based on the appearance feature representation, the video frame feature representation sequence, and the posture feature representation sequence and using the self-attention layer, self-attention processing to generate a first intermediate feature representation sequence and a second intermediate feature representation sequence;
performing, based on the first intermediate feature representation sequence and the second intermediate feature representation sequence and using the cross-attention layer, cross-attention processing to generate a third intermediate feature representation sequence; and
performing, based on the third intermediate feature representation sequence and the facial state feature representation sequence and using the face attention layer, cross-attention processing to generate the output feature representation sequence.

12. The method of claim 1, wherein a training process of the video generation model comprises:
a first training stage, wherein the video generation model and a posture encoder are trained, the posture encoder being trained to extract the posture feature representation sequence from the driving video;
a second training stage, wherein the video generation model and a facial state encoder are trained, the facial state encoder being trained to extract the facial state feature representation sequence from the facial state information; and
a third training stage, wherein the video generation model, the posture encoder, and the facial state encoder are jointly trained.

13. An electronic device, comprising:
at least one processor; and
at least one memory, the at least one memory being coupled to the at least one processor and storing instructions executable by the at least one processor, when executed by the at least one processor, causing the electronic device to perform acts comprising:
determining, based on at least one reference image of a target object, an appearance feature representation indicative of an appearance of the target object;
extracting, based on a driving video corresponding to a driving object, a posture feature representation sequence, the posture feature representation sequence comprising a plurality of posture feature representations corresponding to a plurality of video frames in the driving video, each posture feature representation indicative of a body posture of the driving object in a corresponding video frame;
extracting, based on facial state information indicative of a facial state of the driving object, a facial state feature representation sequence, the facial state feature representation sequence comprising a plurality of facial state feature representations; and
generating, based on the appearance feature representation, the posture feature representation sequence, and the facial state feature representation sequence and using a trained video generation model, a target video, the target video comprising the target object, and a body posture and a facial state of the target object in the target video corresponding to the driving video and the facial state information, respectively.

14. The electronic device of claim 13, wherein extracting the posture feature representation sequence comprises:
extracting a body feature and a head feature of the driving object from a video frame of the plurality of video frames, each body feature indicative of a body posture of the driving object in a corresponding video frame, and each head feature indicative of a head posture of the driving object in a corresponding video frame; and
obtaining the posture feature representation corresponding to each of the plurality of video frames based on performing feature encoding on the body feature and the head feature that correspond to each of the plurality of video frames.

15. The electronic device of claim 14, wherein extracting the body feature comprises: for a first video frame of the plurality of video frames,
determining a first skeleton representation corresponding to the driving object in a three-dimensional space corresponding to the first video frame; and
generating a body skeleton representation that is to be used as the body feature corresponding to the first video frame by projecting the first skeleton representation onto a two-dimensional projection plane.

16. The electronic device of claim 15, wherein generating the body skeleton representation comprises:
determining, based on a first reference image of the at least one reference image, a second skeleton representation corresponding to the target object in a three-dimensional space corresponding to the first reference image;
correcting the first skeleton representation based on a bone proportion between the first skeleton representation and the second skeleton representation; and
projecting the corrected first skeleton onto the two-dimensional projection plane to generate the body skeleton representation.

17. The electronic device of claim 14, wherein extracting the head feature comprises: for a second video frame of the plurality of video frames,
determining a three-dimensional sphere representation corresponding to a head of the driving object in a three-dimensional space corresponding to the second video frame; and
generating a head sphere representation that is to be used as the head feature corresponding to the second video frame based on a projection of the three-dimensional sphere representation on a two-dimensional projection plane.

18. The electronic device of claim 17, wherein the head sphere representation comprises a projection pattern of the three-dimensional sphere representation on the two-dimensional projection plane, a position of the projection pattern in the head sphere representation indicative of a position of the head of the driving object in the corresponding video frame, and a color of the projection pattern indicative of an orientation of the head of the driving object in the corresponding video frame.

19. The electronic device of claim 13, wherein the at least one reference image comprises a second reference image, and determining the appearance feature representation comprises:
generating, based on the second reference image and using a trained image generation model, at least one third reference image, a viewing angle of the target object in the second reference image being different from a viewing angle of the target object in a third reference image of the at least one third reference image; and
determining, based on the second reference image and the at least one third reference image, the appearance feature representation indicative of the appearance of the target object.

20. A non-transitory computer-readable storage medium having computer-executable instructions stored thereon, the computer-executable instructions being executable by a processor to perform acts comprising:
determining, based on at least one reference image of a target object, an appearance feature representation indicative of an appearance of the target object;
extracting, based on a driving video corresponding to a driving object, a posture feature representation sequence, the posture feature representation sequence comprising a plurality of posture feature representations corresponding to a plurality of video frames in the driving video, each posture feature representation indicative of a body posture of the driving object in a corresponding video frame;
extracting, based on facial state information indicative of a facial state of the driving object, a facial state feature representation sequence, the facial state feature representation sequence comprising a plurality of facial state feature representations; and
generating, based on the appearance feature representation, the posture feature representation sequence, and the facial state feature representation sequence and using a trained video generation model, a target video, the target video comprising the target object, and a body posture and a facial state of the target object in the target video corresponding to the driving video and the facial state information, respectively.
